(19) United States
(12) Patent Application Publication
(10) Pub. No.: US 2011/0154168 A1
(43) Pub. Date: Jun. 23, 2011

(54) EFFECTIVE HIGH-SPEED LDPC ENCODING METHOD AND APPARATUS USING THE SAME

(75) Inventors: Yong Ho LEE, Daejeon (KR); Dae lg CHANG, Daejeon (KR); Ho Jin LEE, Daejeon (KR)

(73) Assignee: ELECTRONICS AND TELECOMMUNICATIONS RESEARCH INSTITUTE, Daejeon-City (KR)

(21) Appl. No.: 12/971,180

(22) Filed: Dec. 17, 2010

(30) Foreign Application Priority Data
Dec. 18, 2009 (KR) 10-2009-0127357
May 20, 2010 (KR) 10-2010-0047527

(51) Int. Cl. G06F 11/10

(52) U.S. Cl. 714/801; 714/E11.053

(57) ABSTRACT

Disclosed is an effective high-speed encoding method using a parity-check matrix proposed in an IEEE 802.1x standard for high-speed low-density parity-check encoding. In the prior art, encoding was performed by blocking and dividing the parity-check matrix of the LDPC code and through relevant matrix equations, or encoding was performed by an encoding apparatus that divides a matrix multiplication operation of a generated matrix acquired by using an arbitrary parity-check matrix of a quasi-cyclic (QC) LDPC code and information vectors into two sequential steps and implements each step as a cyclic shift-register. Unlike the prior art, the present invention provides an effective high-speed encoding method having low additional complexity by using a quasi-cyclic characteristic of a parity-check matrix as well as an encoding method through generation of a temporary parity bit, generation of a correction bit, and correction of a parity bit by using the parity-check matrix having a dual-diagonal parity structure proposed in the standard.

### CROSS-REFERENCE TO RELATED APPLICATIONS

This application claims priority under 35 U.S.C. §119 to Korean Patent Application No. 10-2009-0127357, filed on Dec. 18, 2009, and Korean Patent Application No. 10-2010-0097527, filed on May 20, 2010, in the Korean Intellectual Property Office, the disclosure of which is incorporated herein by reference in its entirety.

### BACKGROUND OF THE INVENTION

1. Field of the Invention

The present invention relates to a wire/wireless communication system, and more particularly, to, among methods that belong to a channel coding technology field, an encoding method generating a low density parity-check (LDPC) code.

2. Description of the Related Art

In a wire/wireless communication system, a signal transmitted in a digital form may not be demodulated at a receiver depending on a channel condition. Among various techniques which are adopted in order to reduce error occurrence rate which is increased due to high-speed communication, a channel coding technique is representatively adopted. In recent years, the channel coding technique has been applied to almost all wireless communication systems. In particular, an LDPC code is becoming a focus as a next-generation channel codec in the wireless communication system. First, it is assumed that the LDPC code is encoded by a systematic method. That is, a part of a packet is configured in the same form as inputted bits and the rest part of the packet is configured by a parity bit acquired through the inputted bits. Accordingly, only when input signals are inputted into all blocks that take charge of an encoding function, an encoding operation is performed. A ratio at which the parity bit corresponds to the entire packet depends on encoding rate. Accordingly, the encoding rate is fixed by a parity-check matrix.

The LDPC code is designed by Gallager. The LDPC code is defined by the parity-check matrix of which a small minority of elements have a value of 1 and the rest of most elements have a value of 0.

The LDPC code is divided into a regular LDPC code and an irregular LDPC code. In the case of the regular LDPC code, all rows in the parity-check matrix have the same number of is as elements and all columns also have the same number of is as elements. Contrary to this, in the parity-check matrix of the irregular LDPC code, rows including different numbers of 1s are provided or columns including different numbers of 1s are provided. In general, it has been known that error correction performance of the irregular LDPC code is more excellent than that of the regular LDPC code.

Meanwhile, Fossorier has proposed a quasi-cyclic LDPC code (“Quasi-Cyclic Low Density Parity Check Codes from Circulant Permutation Matrices”, EEE Trans. Inform. Theory, vol. 50, pp. 1788-1794, August 2004) representing the elements of the parity-check matrix by a cyclically shifted identity matrix and a matrix of 0, not 0 and 1 which are elements on GF(2). The LDPC code adopted in IEEE 802.16e or 802.11n is an irregular type quasi-cyclic LDPC code and a parity bit part has a block-type dual-diagonal matrix form.

As the prior art, Richardson (“Efficient Encoding of Low-Density Parity-Check Codes”, IEEE Transactions on Information Theory, Vol. 47, No. 2, February 2001) has proposed a method of generating parity bits by simultaneous equations of input vectors and sub-matrices by blocking and dividing the parity-check matrix of the LDPC code, generating parity bits through relevant matrix equations, and subdividing the parity-check matrices into six sub-matrices.

Contrary to this, Zongwang Li, etc., (“Efficient Encoding of Quasi-Cyclic Low-Density Parity-Check Codes”, IEEE Transactions on Communications, Vol. 54, No. 2, January 2006) has proposed a technique of generating parity bits through an encoding apparatus that divides a matrix multiplication operation of a generation matrix acquired by using the parity-check matrix of the QC-LDPC code and information bits into two sequential steps and implements each step as a cyclic shift-register.

In the prior art, complexity of hardware is increased in implementation and the number of all clocks consumed is increased while performing continuous encoding.

### SUMMARY OF THE INVENTION

There is an object of the present invention to perform high-speed LDPC encoding through low additional complexity by preventing complexity generated by a non-linear operation and directly using a parity-check matrix proposed in a standard.

There is another object of the present invention to provide an effective high-speed LDPC encoding apparatus through low additional linear complexity by using a parity-check matrix proposed in an IEEE 802.1x standard instead of an arbitrary parity-check matrix of the LDPC code in implementing an LDPC encoding apparatus.

The objects of the present invention are not limited to the above-mentioned objects and other undescribed objects will be apparently appreciated by those skilled in the art from the following descriptions.

In order to achieve the above-mentioned objects, an LDPC encoding method according an aspect of the present invention includes performing LDPC encoding by a unique method different from a known encoding method by using a parity-check matrix proposed in an IEEE 802.1x standard instead of an arbitrary parity-check matrix of an LDPC code.

The LDPC encoding method may include performing entire encoding through successive execution of partial encoding operations by applying a quasi-cyclic characteristic of the parity-check matrix to the encoding method.

In particular, the LDPC encoding method according to the aspect of the present invention maximally reduces the number of cyclic shift-registers under an idle state. In addition, the LDPC encoding method according to the aspect of the present invention performs high-speed encoding by partially starting encoding of individual information vectors while partitioning each of square matrices constituting the parity-check matrix proposed in the standard per row at a regular interval.

In order to achieve the above-mentioned objects, an LDPC encoding apparatus according to another aspect of the present invention includes: an arbitrary parity bit generation block generating an arbitrary parity bit; a temporary parity bit generation block generating a temporary parity bit corresponding to the arbitrary parity bit every clock by receiving the arbitrary parity bit and an information vector; a correction bit generation block generating a correction bit corresponding to the arbitrary parity bit every clock by receiving the arbitrary parity bit and the temporary parity bit; and a parity bit correction block generating a corrected parity bit every clock by receiving the arbitrary parity bit, the temporary parity bit, and the correction bit.

According to an embodiment of the present invention, by applying an effective high-speed LDPC encoding apparatus to a wire/wireless communication system, linear complexity is generated by an encoding method directly using a parity-check matrix in implementing the encoding apparatus, thereby reducing complexity of hardware in comparison with known methods.

Continuous encoding of a plurality of information vectors has an advantage of implementing a more effective encoding apparatus by decreasing the number of all clocks consumed for continuous encoding through efficiently using a register of an encoding apparatus.

Further, it is possible to increase the speed of the encoding apparatus through a method of dividing a circulant permutation matrix at regular intervals per row with low additional complexity as necessary.

### BRIEF DESCRIPTION OF THE DRAWINGS

FIG. 1 is a block diagram of an LDPC encoding apparatus according to an embodiment of the present invention;

FIG. 2 is a configuration diagram of a temporary parity bit generation block configuring an LDPC encoding apparatus according to an embodiment of the present invention;

FIG. 3 is a diagram showing an operation clock of each block when an LDPC encoding apparatus is implemented according to an embodiment of the present invention;

FIG. 4 is a configuration diagram of an encoding apparatus using a circular matrix of a parity-check matrix as one example of an LDPC encoding apparatus according to an embodiment of the present invention;

FIG. 5 is a configuration diagram of an encoding apparatus using a parity-check matrix in which s_{0,k} and s_{M-1,K} are changed to 0 by extending an encoding apparatus using a mother matrix shown in FIG. 4 assuming that the size of a circulant permutation matrix is 5;

FIG. 6 is a configuration diagram of an encoding apparatus using a parity-check matrix as it is by extending an encoding apparatus using a circular matrix of a parity-check matrix of FIG. 4 assuming that the size of a circulant permutation matrix is 5;

FIG. 7 is a diagram showing values inputted into an arbitrary register of an encoding apparatus of FIG. 6 on the basis of a clock when an encoding apparatus of FIG. 6 continuously performs encoding of various information vectors;

FIG. 8 is a configuration diagram of an encoding apparatus of a double speed faster than an encoding apparatus when a square matrix is not partitioned assuming that the size of a circulant permutation matrix is 6;

FIG. 9 is a diagram of a parity-check matrix having ½ code rate and a codeword length of 1944 bits proposed in an actual IEEE 802.11n standard; and

FIG. 10 is a flowchart showing an LDPC encoding method according to another embodiment of the present invention.

### DETAILED DESCRIPTION OF THE PREFERRED EMBODIMENTS

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable those skilled in the art to thoroughly understand the teaching of the present invention and to completely inform the scope of the present invention and the exemplary embodiment is just defined by the scope of the appended claims. Meanwhile, terms used in the specification are used to explain the embodiments and not to limit the present invention. In the specification, a singular type may also be used as a plural type unless stated specifically.

Hereinafter, preferred embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

Prior to describing the present invention, a related writing method of the QC-LDPC code and a parity-check matrix H proposed in the IEEE 802.11n and 802.16e standards will be described. A circulant permutation matrix is defined as a square matrix in which rows have the same weight and a top row to a bottom row are cyclically disposed. Further, the first row of the circulant permutation matrix is defined as a generator of the circulant permutation matrix. The circulant permutation matrix is completely generatable through the generator and is represented by the generator. As one example, a circulant permutation matrix of which the rows have a weight of 1 may be defined. Specifically, a matrix A=(A_{i,j}) is defined as a B×B permutation matrix defined by Equations 1 and 2.

$$\begin{matrix}{A}_{i , j} = \{ \begin{matrix}1 & if i {⊕}_{B} 1 = j \\ 0 & otherwise\end{matrix} & [ Equation 1 ] \\ a {⊕}_{B} b ≡ ( a + b ) mod B & [ Equation 2 ]\end{matrix}$$

A matrix Aⁱ is defined as a circulant permutation matrix in which a B×B identity matrix is shifted right by i with respect to i which is in the range of integers 0 to B−1. A B×B zero matrix is defined as A⁻. Accordingly, i has a sample space of {−, 0, 1, . . . , B−1} and Aⁱ has a sample space of {A⁻, A⁰, A¹, . . . , A^{B-1}}. u is defined as an information vector having a form of u=(u_{i,0}, u_{i,1}, . . . , u_{i,B-1}) with respect to (u₀, u₁, . . . , u_{K-1}) and i which is in the range of integers 0 to K−1. u is encoded as a codeword c having a form of (cₛ|cₚ). cₛ has a form of (u₀, uᵢ, . . . , u_{K-1}) and is defined as a vector of 1×(KB) corresponding to a systematic part of c, and cₚ has a form of pᵢ=(p_{i,0}, p_{i,1}, . . . , p_{i,B-1}) with respect to (p₀, p₁, . . . , p_{M-1}) and i which is in the range of integers 0 to M−1 and is defined as a vector of 1×(MB) corresponding to a parity part of c. All u_{i,j} and p_{i,j} are defined in GF(2). ⊕ is defined as the addition defined in GF(2).

H is (MB)×(NB) matrix and is defined as:

$$H = [ {H}_{s} \vert {H}_{p} ] = [ \begin{matrix}{A}^{{s}_{0 , 0}} & {A}^{{s}_{0 , 1}} & … & {A}^{{s}_{0 , N - 1}} \\ {A}^{{s}_{1 , 0}} & {A}^{{s}_{1 , 1}} & … & {A}^{{s}_{1 , N - 1}} \\ ⋮ & ⋮ & ⋱ & ⋮ \\ {A}^{{s}_{M - 1 , 0}} & {A}^{{s}_{M - 1 , 1}} & … & {A}^{{s}_{M - 1 , N - 1}}\end{matrix} ]$$

and all s_{i,j} are defined in the sample space {−, 0, 1, . . . , B−1}. As described above, an LDPC code encoded by using H constituted by the circulant permutation matrices is defined as a QC-LDPC code. Hₛ is defined as the (MB)×(KB) matrix related with the systematic part of c. Hₚ is defined as the (MB)×(MB) matrix related with the parity part of c. P(H) is defined as a circular matrix of H in which each of a zero matrix and a circulant permutation matrix of H is written as 0 and 1. E(H) is defined as an index matrix of H. E(Hₛ) and E(Hₚ) are also defined in the same manner as E(H). E(H), E(Hₛ), and E(Hₚ) are defined as:

$$E ( H ) = [ \begin{matrix}{s}_{0 , 0} & {s}_{0 , 1} & … & {s}_{0 , N - 1} \\ {s}_{1 , 0} & {s}_{1 , 1} & … & {s}_{1 , N - 1} \\ ⋮ & ⋮ & ⋱ & ⋮ \\ {s}_{M - 1 , 0} & {s}_{M - 1 , 1} & … & {s}_{M - 1 , N - 1}\end{matrix} ] , \\ E ( {H}_{s} ) = [ \begin{matrix}{s}_{0 , 0} & {s}_{0 , 1} & … & {s}_{0 , K - 1} \\ {s}_{1 , 0} & {s}_{1 , 1} & … & {s}_{1 , K - 1} \\ ⋮ & ⋮ & ⋱ & ⋮ \\ {s}_{M - 1 , 0} & {s}_{M - 1 , 1} & … & {s}_{M - 1 , K - 1}\end{matrix} ] , \\ E ( {H}_{p} ) = [ \begin{matrix}{s}_{0 , K} & {s}_{0 , K + 1} & … & {s}_{0 , N - 1} \\ {s}_{1 , K} & {s}_{1 , K + 1} & … & {s}_{1 , N - 1} \\ ⋮ & ⋮ & ⋱ & ⋮ \\ {s}_{M - 1 , K} & {s}_{M - 1 , K + 1} & … & {s}_{M - 1 , N - 1}\end{matrix} ]$$

H proposed in the IEEE 802.11n and 802.16e standards is constituted by the systematic part and the parity part. The systematic part has the circulant permutation matrix form and the parity part has a dual-diagonal parity structure. The dual-diagonal parity structure is defined in a form of

$${s}_{0 , K} = {s}_{M - 1 , K} ; {s}_{\frac{M}{2} , K} = 0 ; {s}_{i , K + i + 1} = 0$$

$$for$$

$$0 \leq i < M - 1 ; {s}_{i , K + i} = 0 for 1 \leq i < M ;$$

s_{i,j}=−elsewhere. As one example, E (Hₚ) at M=6 may be written as

$$[ \begin{matrix}{s}_{0 , 6} & 0 & – & – & – & – \\ – & 0 & 0 & – & – & – \\ – & – & 0 & 0 & – & – \\ 0 & – & – & 0 & 0 & – \\ – & – & – & – & 0 & 0 \\ {s}_{5 , 6} & – & – & – & – & 0\end{matrix} ] .$$

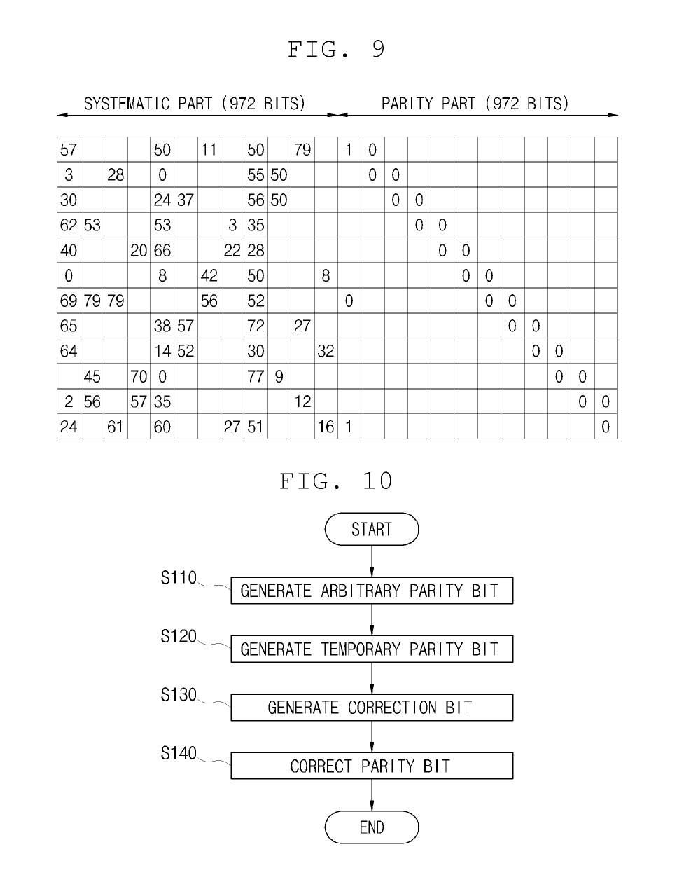

A parity-check matrix having ½ code rate and a codeword length of 1944 bits proposed in an actual IEEE 802.11n standard is shown in FIG. 9.

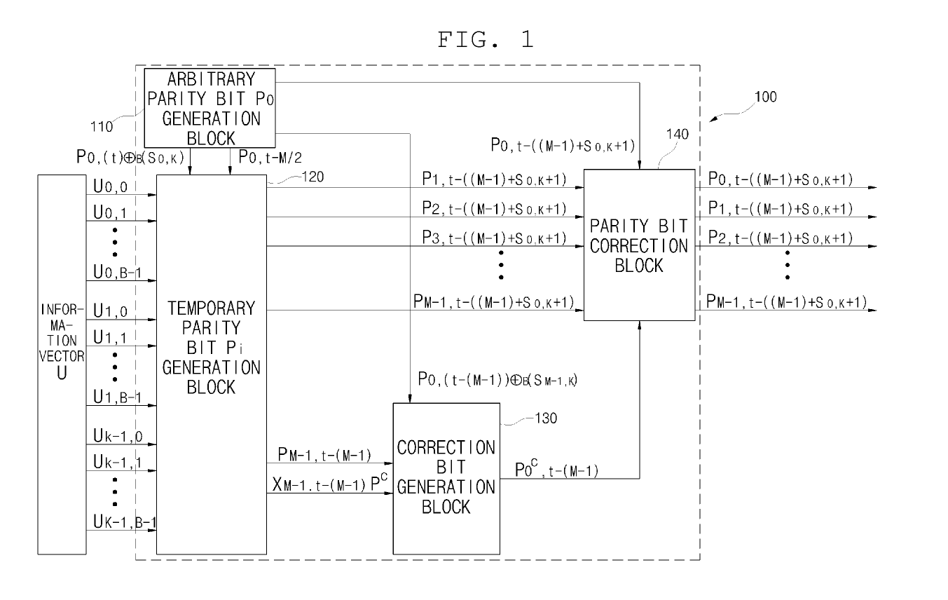

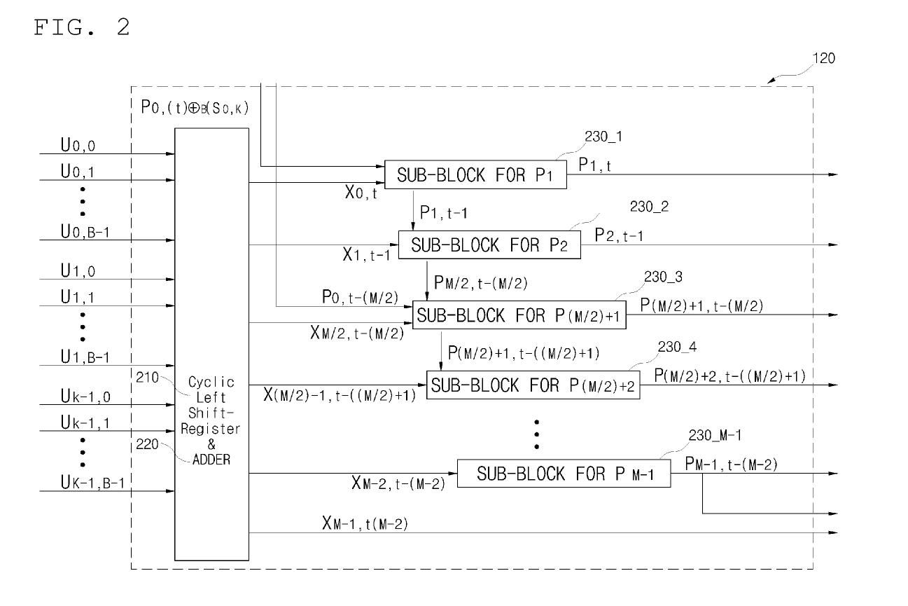

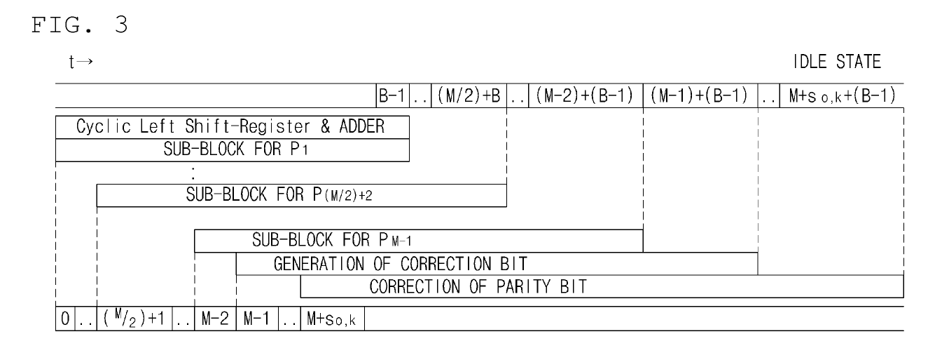

Referring to FIGS. 1 to 3, an LDPC encoding apparatus according to an embodiment of the present invention will be described. FIG. 1 is a block diagram of an LDPC encoding apparatus according to an embodiment, FIG. 2 is a configuration diagram of a temporary parity bit generation block configuring an LDPC encoding apparatus according to an embodiment of the present invention, and FIG. 3 is a diagram showing an operation clock of each block when an LDPC encoding apparatus is implemented according to an embodiment of the present invention. Hereinafter, an operation of each block will be described on the basis of a clock. Herein, t represents a clock index.

Referring to FIG. 1, an encoding method of the present invention using the H proposed in the standards is based on an encoding method using P(H) of the proposed H. If extension from encoding using P(H) to encoding using H is considered at the time of encoding the QC-LDPC code, an effective encoding apparatus can be implemented by adopting a quasi-cyclic characteristic of H.

Specifically, the LDPC encoding apparatus 100 according to the embodiment of the present invention is constituted by an arbitrary parity bit generation block 110, a temporary parity bit generation block 120, a correction bit generation block 130, and a parity bit correction block 140.

The arbitrary parity bit generation block 110 generates an arbitrary parity bit P₀ used in the temporary parity bit generation block 120, the correction bit generation block 130, and the parity bit correction block 140.

Referring to FIG. 2, the temporary parity bit (Pᵢ) generation block 120 is constituted by a cyclic left shift-register 210, an adder 220, and sequential sub-blocks 230 for Pᵢ with respect to which is in the range of integers 1 to M−1. Equations of the cyclic left shift-register 210, the adder 220, and the sequential sub-blocks 220 for Pᵢ on the basis of the clock are expressed as shown in Equation 3. In the case in which an operation of the information vector u and the parity-check matrix is performed while performing the LDPC encoding, the present invention has an advantage of improving effectiveness through a sequential operation of the systematic part and the parity part of the parity-check matrix.

Equation 3 represents an operation in the temporary parity bit generation block 120. In the following equation, a_{i,j} is defined as a generator of A^{s}^{_{i,j}}, uⱼ^{t} is defined as a result vector of cyclic left-shift of uⱼ, and a superscript ^{t} represents a transpose operation of a vector.

$$Cyclic Left \text{-} Register \& Adder \{ 0 \leq t \leq B \} \text{:} \\ {X}_{i , t} = {\sum }_{j = 0}^{K - 1} {{a}_{i , j} ( {u}_{j}^{t} )}^{T} for 0 \leq i \leq M \\ Sub \text{-} block for {P}_{1} \{ 0 \leq t \leq B \} \text{:} \\ {P}_{1 , t} = P \text{?} \text{?} ⊕ {X}_{0 , t} \\ Sub \text{-} block for {P}_{i} ( 2 \leq i \leq M except for i = \frac{M}{2} + 1 ) \{ ( i - 1 ) \leq t \leq ( i - 1 ) + B \} \text{:} \\ {P}_{i , t - ( i - 1 )} = {P}_{i - 1 , t - ( i - 1 )} ⊕ {X}_{i - 1 , t - ( i - 1 )} \\ Sub1 \text{-} block for {P}_{\frac{M}{2} + 1} \{ \frac{M}{2} \leq t \leq \frac{M}{2} + B \} \\ {P}_{\frac{M}{2} + 1 , t - \frac{M}{2}} = {P}_{\frac{M}{2} , t - \frac{M}{2}} ⊕ {P}_{0 , t - \frac{M}{2}} ⊕ {X}_{\frac{M}{2} , t - \frac{M}{2}} \\ \text{?} \text{indicates text missing or illegible when filed} \qquad [ Equation 3 ]$$

An operation of the temporary parity bit generation block 120 will be described in detail below.

Prior to starting encoding, the information vector u is transferred to the cyclic left shift-registers 210 in advance. The cyclic left shift-registers 210 are connected to M adders 220 through global wires. Since the encoding apparatus using H is extended from the encoding apparatus using P(H), the number of global wires required is not increased but maintained as it is. In spite of the extension from P(H) to H, the present invention is characterized in that complexity is not increased.

In order to perform encoding based on the dual-diagonal parity-check matrix proposed in the standards, the arbitrary parity bit generation block 110 arbitrarily generates a parity bit P₀, first of all. For example, the arbitrary parity bit P₀ may be set as a zero vector of 1×B for a simple operation.

Next, the temporary parity bit generation block 120 partially generates other temporary parity bits Pᵢ based on the arbitrary parity bit P₀ every clock with respect to i which is in the range of integers 1 to M−1 for successive (M−2)+B clocks. When the clock is (M−2)+(B−1), other temporary parity bits Pᵢ with respect to i which is in the range of integers 1 to M−1 are completely generated.

The correction bit generation block 130 generates a correction bit p₀^{c} with respect to the arbitrary parity bit P₀. P₀^{c} is also partially generated every clock for successive B clocks. When the clock is (M−1)+(B−1), p₀^{c} is completely generated. An equation of the correction bit generation block 130 based on the block is expressed as shown in Equation 4.

Generation of modified bit P₀^{c}{(M−1)≦t≦(M−1)+B}:

P_{0,t-(M-1)}^{c}=P_{0,(t-(M-1))⊕,(s}_{_{M-1K}}₎⊕P_{M-1,t-(M-1)}⊕X_{M-1,t-(M-1)} [Equation 4]

The parity bit correction block 140 partially corrects the arbitrary parity bit P₀ and other temporary parity bit Pᵢ with respect to i which is in the range of integers 1 to M−1 every clock in the parity part of the parity-check matrix for the successive B clocks as shown in Equation 5 below. As a result, the LDPC encoding apparatus 100 according to the embodiment of the present invention successively performs M parallel part encoding.

$$Modification of parity bit \\ \{ ( M + 1 ) + {s}_{0 , K} + 1 \leq t \leq ( M - 1 ) + {s}_{0 , K} + 1 + B \} \text{:} \\ for i = 0 , \\ P \text{?} = P \text{?} ⊕ P \text{?} \\ for 1 \leq i < \frac{M}{2} + 1 , \\ P \text{?} = P \text{?} ⊕ P \text{?} \\ for \frac{M}{2} + 1 \leq i < M , \\ P \text{?} = P \text{?} ⊕ P \text{?} ⊕ P \text{?} \\ \text{?} \text{indicates text missing or illegible when filed} \qquad [ Equation 5 ]$$

Hereinafter, characteristics of the present invention will be described in comparison with a 2-step encoding method in the prior art developed by Zongwang Li, etc.

First, according to the 2-step encoding method, when clocks consumed for the information vector u inputted into the temporary parity bit generation block 120 are disregarded, M+s_{0,K}+B clocks are consumed to encode KB information bits.

However, according to the embodiment of the present invention, in the case of successively encoding n information vectors u, (M+s_{0,K}+B)+(n−1)×(s_{0,K}+B) clocks less than n×(M+s_{0,K}+B) clocks are consumed.

Second, when the information vector u is encoded by using the encoding method of the embodiment of the present invention, sub-blocks and blocks that are under an idle state exist after a B−1 clock, referring to FIG. 3. The LDPC encoding apparatus 100 according to the embodiment of the present invention can reduce the number of clocks consumed for encoding all the information vectors u by using the sub-blocks and blocks that are under the idle state for encoding the next information vector u at the time of performing successive encoding. The degree of reduction in the number of the consumed clocks depends on B which is the circulant size and s_{0,K} of E(H).

On the contrary, in the 2-step encoding method, until encoding a former information vector u is completed, encoding a subsequent information vector u cannot be performed. When the 2-step encoding method is used at the time of performing successive encoding with respect to n information vectors u, n×(2B) clocks more than the encoding method according to the embodiment of the present invention are consumed.

Third, in terms of using the cyclic left shift-register 210, an operation of the sub-block of each of the cyclic left shift-register 210 and the adder 220 according to the embodiment of the present invention is similar to the first step of the 2-step encoding method. However, the cyclic left shift-register 210 used in the embodiment of the present invention is induced by the extension from the encoding apparatus using P(H) to the encoding apparatus using H and the cyclic left shift-register 210 used in the 2-step encoding method is induced while encoding is performed by applying matrix decomposition to a generation matrix G acquired through H.

Accordingly, the number of global wires connected to the cyclic left shift-register 210 of the LDPC encoding apparatus 100 according to the embodiment of the present invention is equal to the number of global wires connected to the cyclic left shift-register at the first step of the 2-step encoding method.

However, in the case of the 2-step encoding method, the cyclic left shift-register at the second step additionally requires global wires more than the global wires at the first step due to an inverse matrix operation of Hp at the second step.

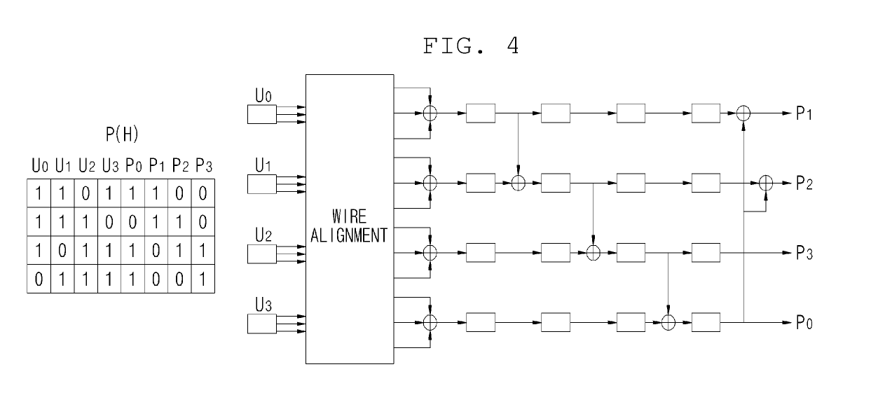

For accurate appreciation of the present invention, hereinafter, an encoding apparatus implemented by using an actual circular matrix P(H) and a parity-check matrix extending P(H) will be described with reference to FIGS. 4 to 8.

Examples of E(H) and E(Gₚ) of E(H) for helping appreciation of the present invention are as follows and a matrix Gₚ is defined as a matrix corresponding to the parity part of the systematic G. E(Gₚ) is defined by circulant index forms which is the sum of the circulant permutation matrices. As one example, a circulant having an index of 0⋄1⋄4 is defined by the sum of circulant permutation matrices A0, A1, and A4.

$$E ( H ) = [ \begin{matrix}4 & 3 & – & 2 & 1 & 0 & – & – \\ 0 & 2 & 0 & – & – & 0 & 0 & – \\ 1 & – & 3 & 1 & 0 & – & 0 & 0 \\ – & 4 & 1 & 3 & 1 & – & – & 0\end{matrix} ]$$

$$E ( {G}_{p} ) = {[ \begin{matrix}0 ◇1◇4 & 0 ◇1◇3◇4 & 1 ◇3◇4 & 0 ◇3◇4 \\ 1 ◇2◇3 & 0 ◇1 & 0 ◇1◇3 & 0 ◇2 \\ 0 ◇2◇4 & 1 ◇3◇4 & 0 ◇1◇3◇4 & 1 ◇3 \\ 2 ◇3◇4 & 1 ◇2 & 1 ◇2 & 1 ◇3\end{matrix} ]}_{\vert}$$

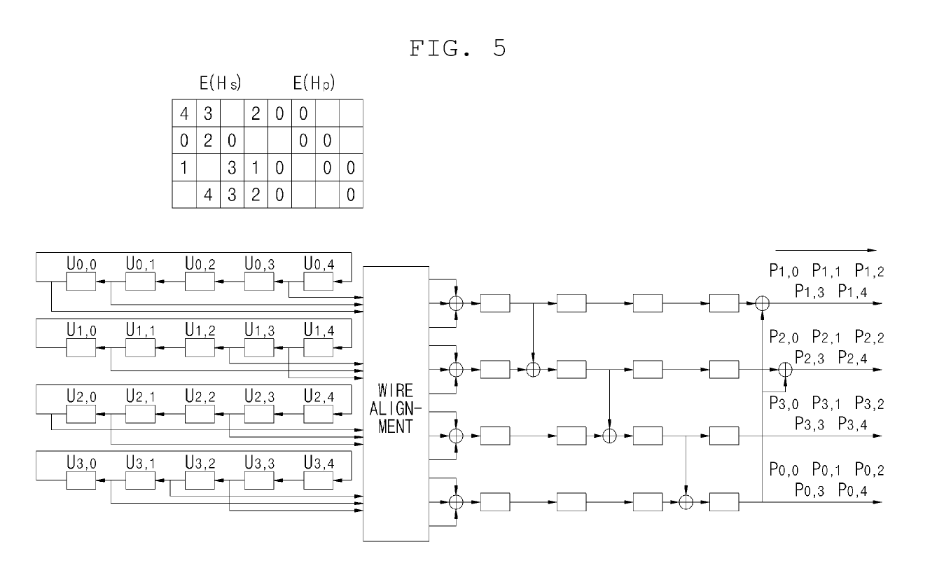

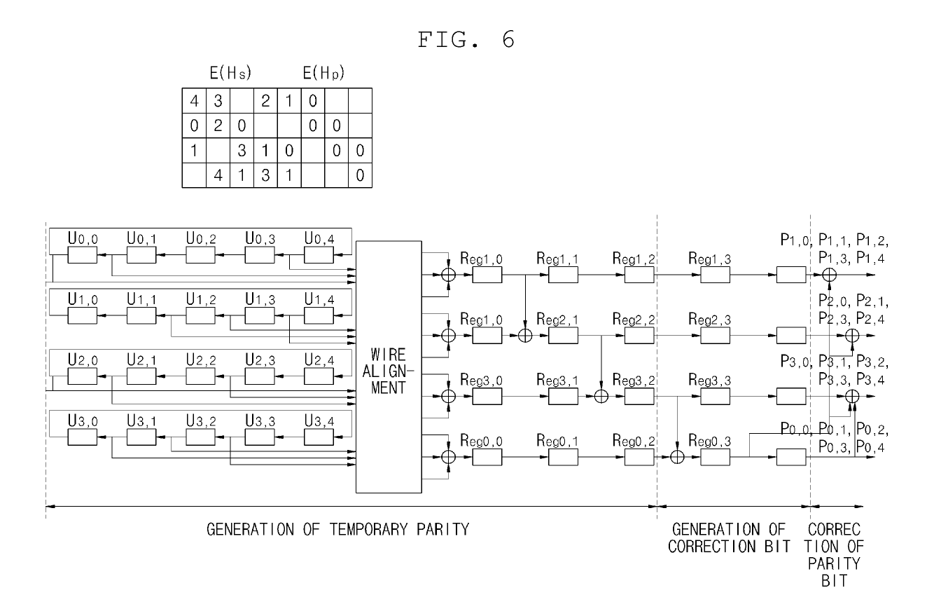

FIG. 4 is a configuration diagram of an encoding apparatus using a circular matrix of a parity-check matrix as one example of an LDPC encoding apparatus according to an embodiment of the present invention, FIG. 5 is a configuration diagram of an encoding apparatus using H in which s_{0,k} and s_{M-1,K} are changed to 0 by extending an encoding apparatus using P(H) of FIG. 4 assuming that the size of a circulant permutation matrix is 5, and FIG. 6 is a configuration diagram of an encoding apparatus using H as it is by extending an encoding apparatus using P(H) of FIG. 4 assuming that the size of a circulant permutation matrix is 5. In this example, all arbitrary parity bits P₀ of the LDPC encoding apparatuses 100 implemented in FIGS. 4, 5, and 6 are set as zero vectors for a simple operation.

Referring to FIGS. 4, 5, and 6, even though twelve 1 bits of P(H) are extended to sixty 1 bits of H, the number of global wires connected to each wire alignment block is not increased but maintained as it is.

Referring to FIGS. 5 and 6, the LDPC encoding apparatus 100 according to the embodiment of the present invention may be implemented with minimal change even though values of s_{0,K} and s_{M-1,K} of H proposed in the standards have 0 and 1 and furthermore, an arbitrary positive integer value.

Specifically, an operation clock of each sub-block 230 in the temporary parity bit generation block 120 is changed from the successive B clocks to B+s_{0,K} clocks and an operation clock of the correction bit generation block 130 is changed from the successive B clocks to B+s_{0,K} clocks to implement the extended LDPC encoding apparatus 100. Further, in terms of substantially implementing the LDPC encoding apparatus 100, an adder of P_{3,i} with respect to i which is in the range of integers 0 to 3 and gray registers are used. On the basis of the encoding apparatus using P(H), the extended LDPC encoding apparatus 100 according to the embodiment of the present invention requires additional s_{0,K} gray register column vectors in accordance with s_{0,K}.

Referring to FIG. 6, the LDPC encoding apparatus 100 encodes all information vectors u by using cyclic left shift of the cyclic left shift register 210 for 10 clocks, generates P_{0,0}, P_{1,0}, P_{2,0}, and P_{3,0} at the 6-th clock among the 10 clocks and successively generates P_{0,i}, P_{1,i}, P_{2,i}, and P_{3,i} with respect to i which is in the range of integers 1 to 4 every clock for the rest of the 4 clocks.

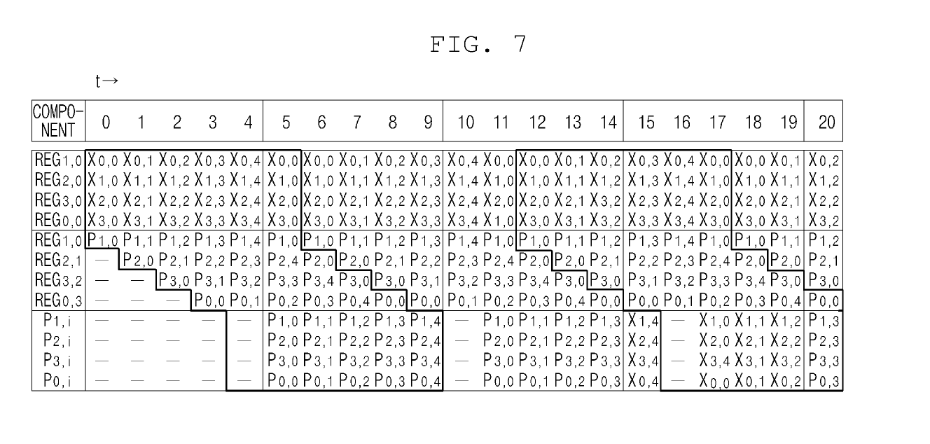

FIG. 7 shows values inputted into an arbitrary register on the basis of a clock when an LDPC encoding apparatus 100 shown in FIG. 6 successively performs encoding of a plurality of information vectors u. Referring to FIG. 7, when the LDPC encoding apparatus 100 shown in FIG. 6 successively encodes the plurality of information vectors u, 4-parallel partial encoding is successively performed for successive B clocks in the parity bit correction block 140.

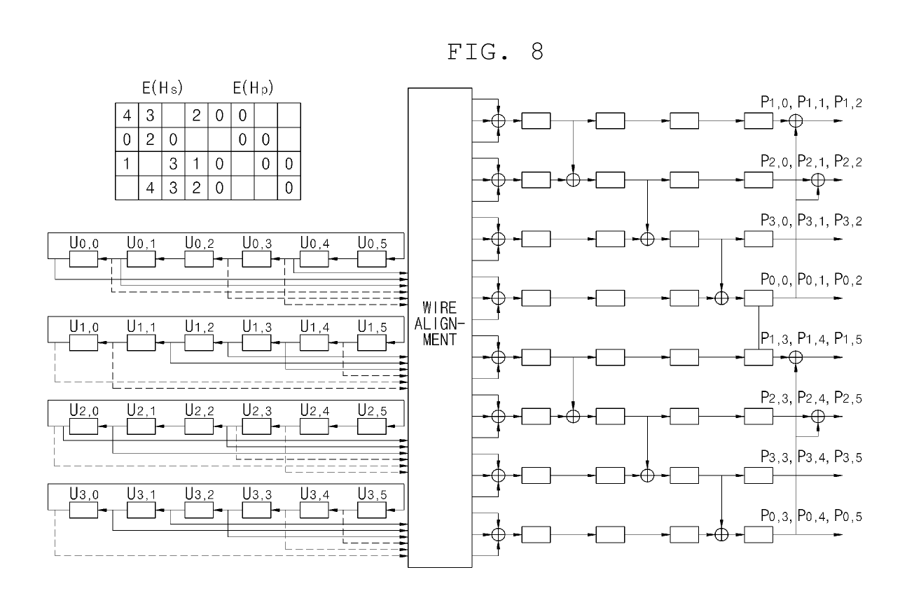

FIG. 8 is a configuration diagram of a double-speed encoding apparatus according to an embodiment of the present invention acquired by partitioning a square matrix assuming that a circulant size is 6. Referring to FIG. 8, the LDPC encoding apparatus 100 according to the embodiment of the present invention may encode the information vectors u at a double speed faster than the 2-step encoding method in the prior art due to low linear additional complexity. Further, in this case, it is possible to increase the encoding speed up to 3 times. The increment degree of the encoding speed of the LDPC encoding apparatus 100 according to the embodiment of the present invention depends on the circulant size and a row-unit partitioning interval.

Referring to FIGS. 1 and 10, an LDPC encoding method according to another embodiment of the present invention will be described. FIG. 10 is a flowchart showing an LDPC encoding method according to another embodiment of the present invention.

Referring to FIGS. 1 and 10, in the LDPC encoding method according to the embodiment of the present invention, in order to perform encoding based on the dual-diagonal parity-check matrix proposed in the standards, an arbitrary parity bit P₀ is first generated (S110). For example, the arbitrary parity bit P₀ may be set as a zero vector of 1×B for a simple operation.

Next, the temporary parity bit generation block 120 adds and converts received information vectors and partially generates a temporary parity bit in sequence every clock by using the converted vector X and the arbitrary parity bit (S120). For example, the temporary parity bit generation block 120 partially generates other temporary parity bits Pᵢ based on the arbitrary parity bit P₀ every clock with respect to i which is in the range of integers 1 to M−1 for successive (M−2)+B clocks by using Equation 1. When the clock is (M−2)+(B−1), other temporary parity bits Pᵢ with respect to i which is in the range of integers 1 to M−1 are completely generated.

Next, the correction bit generation block 130 generates a correction bit P₀^{c} with respect to the arbitrary parity bit P₀ (S130). P₀^{c} is also partially generated every clock for successive B clocks. When the clock is (M−1)+(B−1), P₀^{c} is completely generated. An equation of the correction bit generation block 130 based on the clock is expressed as shown in Equation 2.

The parity bit correction block 140 partially corrects the arbitrary parity bit P₀ and other temporary parity bit Pᵢ with respect to i which is in the range of integers 1 to M−1 every clock for the successive B clocks as shown in Equation 3 (S140). As a result, the LDPC encoding apparatus 100 according to the embodiment of the present invention successively performs M parallel part encoding.

In the encoding apparatus according to another embodiment of the present invention, partitioning each of square matrices constituting the parity-check matrix per row at a regular interval enables the encoding operation so as to perform high-speed encoding. Herein, the encoding speed of the information vector u depends on the size of the square matrix and a row-unit partitioning interval of the square matrix.

While certain embodiments have been described above, it will be understood to those skilled in the art that the embodiments described are by way of example only. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An LDPC encoding apparatus performing encoding with a low density parity check (LDPC) code by using a parity-check matrix, comprising:
an arbitrary parity bit generation block generating an arbitrary parity bit;
a temporary parity bit generation block generating a temporary parity bit corresponding to the arbitrary parity bit every clock by receiving the arbitrary parity bit and an information vector;
a correction bit generation block generating a correction bit corresponding to the arbitrary parity bit every clock by receiving the arbitrary parity bit and the temporary parity bit; and
a parity bit correction block generating a corrected parity bit every clock by receiving the arbitrary parity bit, the temporary parity bit, and the correction bit.

2. The LDPC encoding apparatus according to claim 1, wherein the parity-check matrix includes a systematic part having a circulant permutation matrix form and a parity part, wherein the parity part has a dual-diagonal structure.

3. The LDPC encoding apparatus according to claim 1, wherein the temporary parity bit generation block includes:
a plurality of cyclic left shift-registers shifting the inputted information vector;
a plurality of adder sub-blocks connected with the cyclic left shift-registers through global wires and adding the information vector; and
a plurality of temporary parity sub-blocks sequentially generating the temporary parity bit.

4. The LDPC encoding apparatus according to claim 3, wherein the number of global wires required due to extension of an LDPC encoding scheme using a circular matrix of the parity-check matrix is maintained as it is.

5. The LDPC encoding apparatus according to claim 3, wherein the temporary parity bit generation block performs multiplication of the information vector and the systematic part of the parity-check matrix by using the global wire and the cyclic left shift-register.

6. The LDPC encoding apparatus according to claim 3, wherein the cyclic left shift-register is implemented in parallel, and
entire encoding is performed by successively executing generation of the temporary parity bit, generation of the correction bit, and partial generation of the corrected parity bit every clock.

7. The LDPC encoding apparatus according to claim 3, wherein the temporary parity generation block uses the cyclic left shift-register and the temporary parity sub-block that are under an idle state while encoding a current information vector for encoding a subsequent information vector at the time of successively encoding the inputted information vectors.

8. The LDPC encoding apparatus according to claim 2, wherein the circulant permutation matrix included in the parity-check matrix is partitioned per row at a regular interval and the information vectors are partially encoded at the same time by using the systematic part.

9. The LDPC encoding apparatus according to claim 8, wherein an encoding speed of the information vector is changed depending on the size of the circulant permutation matrix and a row-unit partitioning interval of the circulant permutation matrix.

10. An LDPC encoding method performing encoding with a low density parity check (LDPC) code by using a parity-check matrix, comprising:
generating an arbitrary parity bit;
generating a temporary parity bit corresponding to the arbitrary parity bit every clock by receiving the arbitrary parity bit and an information vector to be transmitted;
generating a correction bit corresponding to the arbitrary parity bit every clock by receiving the arbitrary parity bit and the temporary parity bit; and
generating a corrected parity bit every clock by receiving the arbitrary parity bit, the temporary parity bit, and the correction bit.

11. The LDPC encoding method according to claim 10, wherein the parity-check matrix includes a systematic part having a circulant permutation matrix form and a parity part, wherein the parity part has a dual-diagonal structure.

12. The LDPC encoding method according to claim 10, wherein the generating a temporary parity bit includes:
adding and converting the inputted information vector in a plurality of cyclic left shift-registers; and
partially generating temporary parity bits in sequence every clock by using the converted information vector and the arbitrary parity bit in a temporary parity sub-block.

13. The LDPC encoding method according to claim 12, wherein the generating a temporary parity bit uses the cyclic left shift-register and the temporary parity sub-block that are under an idle state while encoding a current information vector for encoding a subsequent information vector at the time of successively encoding the inputted information vectors.

14. The LDPC encoding method according to claim 11, wherein the circulant permutation matrix included in the parity-check matrix is partitioned per row at a regular interval and the information vectors are partially encoded at the same time by using the systematic part.

15. The LDPC encoding method according to claim 14, wherein an encoding speed of the information vector is changed depending on the size of the circulant permutation matrix and a row-unit partitioning interval of the circulant permutation matrix.
